(19) United States
(12) Patent Application Publication
(10) Pub. No.: US 2022/0374806 A1
(43) Pub. Date: Nov. 24, 2022

(54) SYSTEM AND METHOD FOR TRACKING EXERCISE EQUIPMENT USAGE

(71) Applicant: Chimney Hill Ventures LLC, Plano, TX (US)

(72) Inventors: Saharsh Prakash Singh, Plano, TX (US); Shantanu Prakash Singh, Plano, TX (US)

(21) Appl. No.: 17/675,355

(22) Filed: Feb. 18, 2022

Related U.S. Application Data
(60) Provisional application No. 63/191,144, filed on May 20, 2021.

(51) Int. Cl. G06Q 10/06; H04L 67/125; H04W 4/38

(52) U.S. Cl. CPC G06Q 10/06315; H04L 67/125; H04W 4/38

(57) ABSTRACT

An apparatus and computerized method of tracking a usage of an exercise equipment includes providing a sensor operably connected to the exercise equipment, wherein the sensor is in a low power state, automatically exiting the low power state whenever a change in the exercise equipment is detected by the sensor, automatically capturing a usage event associated with the exercise equipment, automatically transmitting a set of data associated with the usage event to a collection application programming interface (API) on a server, automatically entering the low power state of the sensor, storing the set of data associated with the usage event in a database communicably coupled to the server, determining a usage data for the exercise equipment based on the set of data associated with two or more usage events using the server, and transmitting the usage data to one or more remote devices communicably coupled to the server or the database.

### CROSS-REFERENCE TO RELATED APPLICATIONS

This application is a non-provisional patent application of and claims priority to U.S. provisional patent application Ser. No. 63/191,144 filed on May 20, 2021 and entitled “System and Method for Tracking Exercise Equipment Usage.” The foregoing application is hereby incorporated by reference in its entirety.

### TECHNICAL FIELD OF THE INVENTION

The present invention relates in general to fitness devices, and more particularly, to a system and method for tracking fitness device usage.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background is described in connection with fitness centers, exercise equipment and tracking exercise equipment usage.

Fitness center operators currently do not have a streamlined and efficient way to monitor real-time usage of their exercise equipment, which include cardio machines, resistance machines and free weights. This leads fitness center operators to gauge usage and demand for particular exercise equipment primarily through anecdotal precedent, visual observations and sporadic user feedback. Consequently, fitness center operators are unable to leverage actual usage data on their exercise equipment in making important operational decisions, causing significant impacts to underlying user experience and the overall attractiveness of the fitness center.

Due to a lack of proper exercise equipment usage data, fitness center operators are also unable to make proper financial decisions on exercise equipment purchasing/replacement needs. This leads to fitness center operators realizing low return on investment on their purchasing decisions, where the purchased exercise equipment is under utilized and a burden in optimizing a fitness center's floor configuration.

In addition to fitness center operators, real-time exercise equipment usage data is also useful information for fitness center users. Currently, there is not a reliable and efficient manner for fitness center users to gauge real-time activity level inside a fitness center. As a result, fitness center users don't have access to a tool showing them how busy a fitness center is at any given time. Additionally, fitness center users don't have a way to accurately see if a particular machine, such as treadmill or others, is in use and, as a result, not available for them to use at the fitness centers.

### SUMMARY OF THE INVENTION

Various embodiments of a data collection and presentation system are described herein. These embodiments seek to solve some or all of the shortcomings addressed in the background above along with others, which are described herein. At a high level, the systems and methods described herein track exercise equipment usage data at fitness centers and share historical and real time to near real time presentations of such collected data in various curated forms with operators and users of those fitness centers. These embodiments provide a combination of devices and software that automatically communicate with one another to provide technological solutions that are more than mere data collection and analysis.

In one embodiment of the present invention, a computerized method of tracking a usage of an exercise equipment comprises: providing a sensor operably connected to the exercise equipment, wherein the sensor is in a low power state; automatically exiting the low power state whenever a change in the exercise equipment is detected; automatically capturing a usage event associated with the exercise equipment; automatically transmitting a set of data associated with the usage event to a collection application programming interface (API) on a server; automatically entering the low power state; storing the set of data associated with the usage event in a database communicably coupled to the server; determining a usage data for the exercise equipment based on the set of data associated with two or more usage events using the server; and transmitting the usage data to one or more remote devices communicably coupled to the server or the database.

In one aspect, the method further comprises attaching the sensor to the exercise equipment, or integrating the sensor into the exercise equipment. In another aspect, the method further comprises initializing a wireless connection between the sensor and a wireless network. In another aspect, transmitting the set of data associated with the usage event to the collection application programming interface (API) on the server comprises: transmitting the set of data associated with the usage event from the sensor to a first wireless network; transmitting the set of data associated with the usage event from the sensor to a gateway via a first wireless network; and transmitting the set of data associated with the usage event from the gateway to the server via a second wireless network or wired network. In another aspect, the method further comprises storing the set of data associated with the usage event from the sensor at the gateway for later transmission whenever a connection to the server is lost or cannot be established. In another aspect, the method further comprises periodically and automatically exiting the low power state without any change in the exercise equipment, transmitting a heartbeat message to the collection application programming interface (API) on the server, and entering the low power state of the sensor. In another aspect, the heartbeat message comprising a facility identifier, an equipment identifier, a last heartbeat data, and a battery level. In another aspect, the method further comprises receiving an update from the server, and installing the update on the sensor. In another aspect, the usage event comprises a start of the exercise equipment or a stop of the exercise equipment. In another aspect, the set of data associated with the usage event comprises a facility identifier, an equipment identifier, a timestamp and an event identifier. In another aspect, the sensor operates automatically without any action by a user. In another aspect, the usage data is determined in response to a request from the one or more remote devices. In another aspect, the method further comprises predicting a future usage or a usage trend for the exercise equipment based on the usage data and a historical usage. In another aspect, the method further comprises detecting a problem with the exercise equipment based on the usage data. In another aspect, the method further comprises displaying a current usage or a future usage for the exercise equipment or multiple exercise equipment on the one or more remote devices. In another aspect, the method further comprises associating the usage data with a user, wherein the usage data is only available to the user and an operator or owner of the exercise equipment. In another aspect, the method further comprises sending one or more alerts to the one or more remote devices. In another aspect, the usage data is transmitted to the one or more remote devices in real time or near real time. In another aspect, the sensor comprises: an enclosure; one or more sensing elements disposed on or within the enclosure; a microcontroller disposed within the enclosure and connected to the one or more sensing elements; and a power source disposed on or within the enclosure and connected to the one or more sensing elements and the microcontroller. In another aspect, the one or more sensing elements comprise a motion sensor, a vibration sensor, or a seat occupancy sensor. In another aspect, the power source comprises a battery, an electromagnetic energy harvester, a solar cell, or a combination thereof. In another aspect, the method further comprises the sensor interoperates or communicates with an exercise tracking component of the exercise equipment or a personal exercise tracking device. In another aspect: the exercise equipment comprises a weight lifting equipment, a cardio equipment, a dueling ropes, a stretching center, or an ab machine; and the remote device comprises a computer, a laptop, a mobile phone, a personal data assistant, a tablet, a watch, or a wrist band.

In another embodiment of the present invention, a system for tracking a usage of an exercise equipment comprises: a server; a database communicably coupled to the server; one or more sensors operably connected to the exercise equipment, wherein the sensor is in a low power state, automatically exits the low power state whenever a change in the exercise equipment is detected by the sensor, automatically captures a usage event associated with the exercise equipment, automatically transmits a set of data associated with the usage event to a collection application programming interface (API) on the server, and automatically enters the low power state of the sensor; and wherein the server stores the set of data associated with the usage event in the database, and determines a usage data for the exercise equipment based on the set of data associated with two or more usage events.

In one aspect, one or more remote devices are communicably coupled to the server or the database, wherein the server or the database transmits the usage data to the one or more remote devices. In another aspect, the sensor is attached to the exercise equipment, or integrated into the exercise equipment. In another aspect, the sensor initializes a wireless connection with a wireless network. In another aspect, the system further comprises: a gateway; a first wireless network communicably coupling the sensor to the gateway; and a second wireless network or wired network communicably coupling the gateway to the server. In another aspect, the set of data associated with the usage event from the sensor is stored at the gateway for later transmission whenever a connection to the server is lost or cannot be established. In another aspect, the sensor periodically and automatically exits the low power state without any change in the exercise equipment, transmits a heartbeat message to the collection application programming interface (API) on the server, and enters the low power state of the sensor. In another aspect, the heartbeat message comprising a facility identifier, an equipment identifier, a last heartbeat data, and a battery level. In another aspect, the sensor receives an update from the server, and installs the update. In another aspect, the usage event comprises a start of the exercise equipment or a stop of the exercise equipment. In another aspect, the set of data associated with the usage event comprises a facility identifier, an equipment identifier, a timestamp and an event identifier. In another aspect, the sensor operates automatically without any action by a user. In another aspect, the usage data is determined in response to a request from the one or more remote devices. In another aspect, a problem with the exercise equipment is detected based on the usage data. In another aspect, a current usage or a future usage for the exercise equipment or multiple exercise equipment is displayed on the one or more remote devices. In another aspect, the usage data is associated with a user, wherein the usage data is only available to the user and an operator or owner of the exercise equipment. In another aspect, one or more alerts are sent to the one or more remote devices. In another aspect, the usage data is transmitted to the one or more remote devices in real time or near real time. In another aspect, the sensor comprises: an enclosure; one or more sensing elements disposed on or within the enclosure; a microcontroller disposed within the enclosure and connected to the one or more sensing elements; and a power source disposed on or within the enclosure and connected to the one or more sensing elements and the microcontroller. In another aspect, the one or more sensing elements comprise a motion sensor, a vibration sensor, or a seat occupancy sensor. In another aspect, the power source comprises a battery, an electromagnetic energy harvester, a solar cell, or a combination thereof. In another aspect, the sensor interoperates or communicates with an exercise tracking component of the exercise equipment or a personal exercise tracking device. In another aspect: the exercise equipment comprises a weight lifting equipment, a cardio equipment, a dueling ropes, a stretching center, or an ab machine; and the remote device comprises a computer, a laptop, a mobile phone, a personal data assistant, a tablet, a watch, or a wrist band.

In another embodiment of the present invention, a system for tracking a usage of an exercise equipment includes: a server; a database communicably coupled to the server; one or more remote devices communicably coupled to the server or the database; one or more sensors operably connected to the exercise equipment, wherein each sensor comprises, an enclosure, one or more sensing elements disposed on or within the enclosure, a microcontroller disposed within the enclosure and connected to the one or more sensing elements, and a power source disposed on or within the enclosure and connected to the one or more sensing elements and the microcontroller, and wherein each sensor is in a low power state, automatically exits the low power state whenever a change in the exercise equipment is detected, automatically captures a usage event associated with the exercise equipment, automatically transmits a set of data associated with the usage event to a collection application programming interface (API) on the server, and automatically enters the low power state; a gateway; a first wireless network communicably coupling the one or more sensors to the gateway; a second wireless network or wired network communicably coupling the gateway to the server; wherein the server stores the set of data associated with the usage event in the database, and determines a usage data for the exercise equipment based on the set of data associated with two or more usage events; and wherein the server or the database transmits the usage data to the one or more remote devices.

### BRIEF DESCRIPTION OF THE DRAWINGS

For a more complete understanding of the features and advantages of the present invention, reference is now made to the detailed description of the invention along with the accompanying figures and in which:

FIG. 1 depicts a visual representation of an overall system architecture in accordance with one embodiment of the present invention;

FIG. 2 depicts an example placement and estimated size of a sensor attached to different types of exercise equipment in accordance with one embodiment of the present invention;

FIG. 3 depicts a high level description of a sensor's operation in accordance with one embodiment of the present invention;

FIG. 4 depicts a block diagram of a gateway network configuration overview in accordance with one embodiment of the present invention;

FIGS. 5 and 6 depict non-limiting examples of the type of data stored by the collection API in accordance with one embodiment of the present invention;

FIG. 7 depicts an example of the historical usage of exercise equipment use case as presented via a web browser on a desktop personal computer or laptop in accordance with one embodiment of the present invention;

FIG. 8 depicts an illustrative example of a heat map feature for fitness center users in accordance with one embodiment of the present invention;

FIG. 9 depicts a flow chart illustrating a computerized method of tracking a usage of an exercise equipment in accordance with one embodiment of the present invention; and

FIG. 10 depicts a block diagram of system for tracking a usage of an exercise equipment in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Various embodiments of a data collection and presentation system are described herein. These embodiments seek to solve some or all of the shortcomings addressed in the background above along with others, which are described herein. At a high level, the systems and methods described herein track exercise equipment usage data at fitness centers and share historical and real time to near real time presentations of such collected data in various curated forms with operators and users of those fitness centers. These embodiments provide a combination of devices and software that automatically communicate with one another to provide technological solutions that are more than mere data collection and analysis.

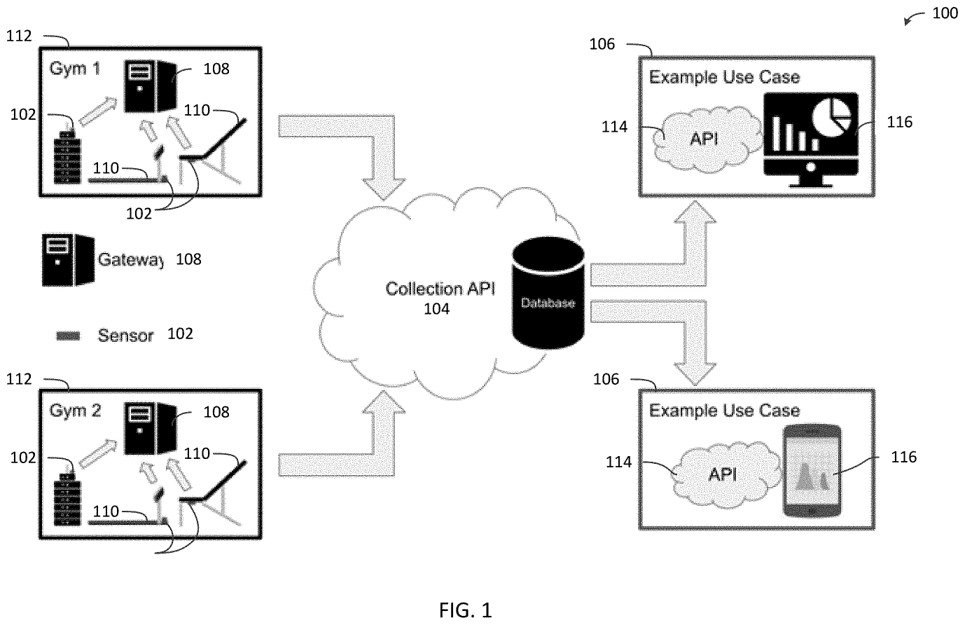

Now referring to FIG. 1, a visual representation of an overall system architecture in accordance with one embodiment of the present invention is shown. The system 100 includes one or more sensors 102, a collection application programming interface (API) 104, and presentation layer 106. The one or more sensors 102 can communicate with the collection API 104 directly or indirectly through various wireless or wired devices (e.g., gateways 108, access points, etc.) and networks.

In one embodiment, the sensors 102 are battery powered and wireless network enabled electronic devices that can be attached to exercise equipment 110 in a fitness center 112. Alternatively, the sensors 102 can be integrated into the exercise equipment 110. The sensors 102 can also be used in other locations where exercise equipment is used, such as homes, schools, rehabilitation centers, etc. Moreover, the sensors 102 can employ alternative power sources (e.g., electromagnetic, solar, etc.) instead of or in addition to a battery. Each sensor 102 is mapped to a specific exercise equipment 110 and detects usage of the exercise equipment 110. The exercise equipment 110 may include weight lifting equipment (e.g., weight bench, barbells, weight plates, resistance bands, squat rack, calf press, etc.), cardio equipment (e.g., treadmill, stationary bike, elliptical machine, glider machine, stair climber, rowing machine, etc.), dueling ropes, stretching center, ab machine, etc.), or other existing and future equipment used for exercise. The data collected by these sensors 102 is transmitted wirelessly in near real time to either a local gateway 108 or the collection API 104. In some embodiments, the sensors 102 may interoperate or communicate with exercise tracking components of the exercise equipment 110 or personal exercise tracking devices.

Each gateway 108, which is optional, is typically deployed and dedicated to an individual fitness center 112. The gateway 108 has two high level responsibilities. First, the gateway 108 acts as a fault tolerant intermediary between the sensors 102 and the collection API 104 with regards to data transmission. Second, the gateway 108 is also used to push configuration and functionality updates to the sensors 102. Note that any hardware and software configuration can be used to exchange data, messages and instructions between the sensors 102 and the collection API 104. The present invention is not limited to the specific transmission paths illustrated herein.

All data collected by sensors 102 is transmitted to the collection API 104 for long term storage. In this non-limiting embodiment, the collection API 104 is a multi-tenant system shared by multiple fitness centers 112 that may belong to numerous different operators/organizations. The collection API 104 recognizes all sensors 102, gateways 108, other relevant equipment and their mappings to exercise equipment 110 and fitness centers 112.

The presentation layer 106 is a generalized class of components (e.g., user API 114 loaded on a user device 116) that curate and present the data stored via the collection API 104 to serve the purpose of specific use cases. The user devices 116 are also referred to as remote devices and may include computers, laptops, mobile phones, personal data assistants, tablets, watches, wrist bands, or any other existing or future communications device used by end users.

In this embodiment, the sensors 102 are battery powered and wireless-network enabled electronic devices that can be attached to exercise equipment 110 in a fitness center 112 or other location. Alternatively, the sensors 102 can be integrated into the exercise equipment 110. The sensors 102 can employ alternative power sources (e.g., electromagnetic harvesting, solar, etc.) instead of or in addition to a battery. Each sensor 102 typically contains a power source, sensor variant, microcontroller, and device enclosure.

The power source typically includes batteries that may optionally be connected to a voltage regulator and supply power to the electronic circuit containing the specific sensor variant and the wireless-network enabled microcontroller. The power source may also employ alternative power sources (e.g., electromagnetic harvesting, solar, etc.) instead of or in addition to a battery.

The sensor variant is one of various sensor technologies that can be integrated with microcontrollers. The specific variant used for a particular sensor device depends on the exercise equipment 110 to which the sensor 102 is attached. Common variants include motion or vibration sensors (e.g., accelerometers, etc.), seat occupancy sensors (e.g., force sensing resistors, load cells, etc.), or other existing or future developed sensor.

The wireless network enabled microcontroller examines the sensor variant to determine when usage of an exercise equipment 110 starts and ends (i.e., a usage event). Other usage events can be detected or monitored by the sensor 102. The microcontroller logs the beginning and end of equipment 110 usage by transmitting to either the local gateway or the collection API. In the interest of power efficiency and maximizing battery life, the microcontroller is configured to disable most of its functionality and enter a “low power” state until an “interesting” reading is made on the sensor variant. What reading is considered “interesting” depends on the sensor variant. Examples include an accelerometer detecting that motion has either started or stopped, or a force sensing resistor reporting significant increase or decrease. The “interesting” reading is then used by the microcontroller as a “wake up” event. The “wake up” event triggers the microcontroller to exit the “low power” state, process the sensor reading, and notify the gateway 108 or collection API 104 of the equipment usage event. The microcontroller also wakes up periodically (e.g. a few times a day), independently of a usage event, to transmit a “heartbeat” message. This heartbeat message is used to keep track of the operational status of each sensor 102 in the collection API 104 database.

Each sensor 102 needs to be securely attached to various types of exercise equipment 110 without contributing significant changes to the weight, balanced and aesthetics of the host exercise equipment 110. The enclosure is built to minimize the size, volume, and weight of the sensor 102. The sensor 102 is typically attached to host equipment 110 using a strong adhesive or a mechanical attachment to ensure the sensor 102 remains securely attached to its host equipment 110 while withstanding typical usage of that exercise equipment 110. Alternatively, the sensor 102 can be integrated into or interface with the exercise equipment 110.

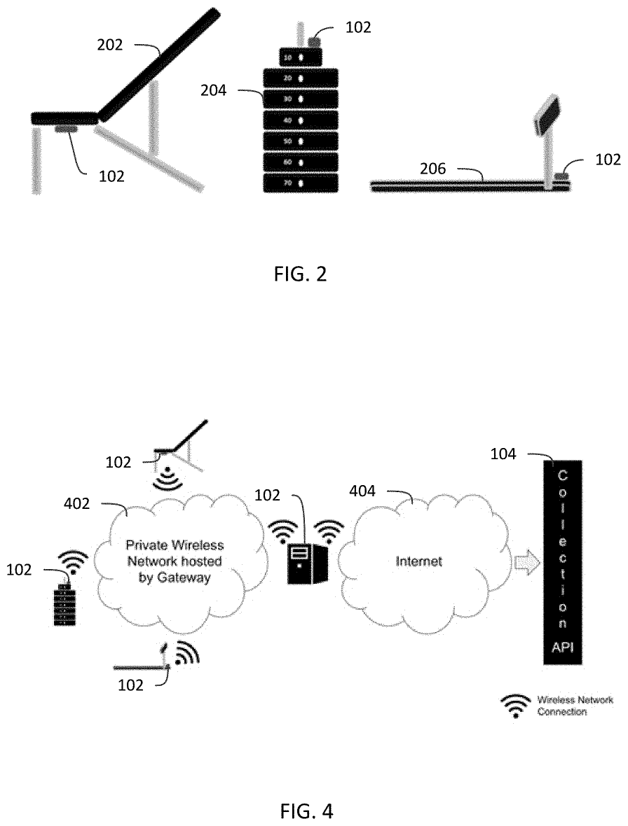

Referring now to FIG. 2, an example placement and estimated size of a sensor 102 attached to different types of exercise equipment in accordance with one embodiment of the present invention is shown. As shown, the example exercise equipment 110, from left to right, are an exercise bench 202, a resistance machine weight plate stack 204, and a treadmill 206. The exercise bench 202 is an example of an exercise equipment that uses the seat occupancy sensor variant. The resistance machine weight plate stack 204 is an example of an equipment that uses the motion detector sensor variant. A treadmill 206 is an example of an equipment that uses the vibration sensor variant. The sensors 102 are shown as a shape attached to each equipment to illustrate the estimated size of a typical sensor 102 in relation to typical exercise equipment found in typical fitness centers.

Given the sensors will be typically retrofitted onto the equipment in the fitness center, an extension of the collected data can include the number of reps and the amount of resistance weight a person completes during a set and/or session with the exercise equipment. For example, a weight based sensor can detect usage events based on changes in measured weight. Such a sensor can be installed at the bottom of the weight plates of a resistance machine. A reduction in measured weight signals the start of a repetition. The amount of negative weight change is equal to the amount of resistance weight used for the exercise. A positive change should restore the measured weight back to its original value. Thus, a positive change to the measured weight signals the end of a repetition.

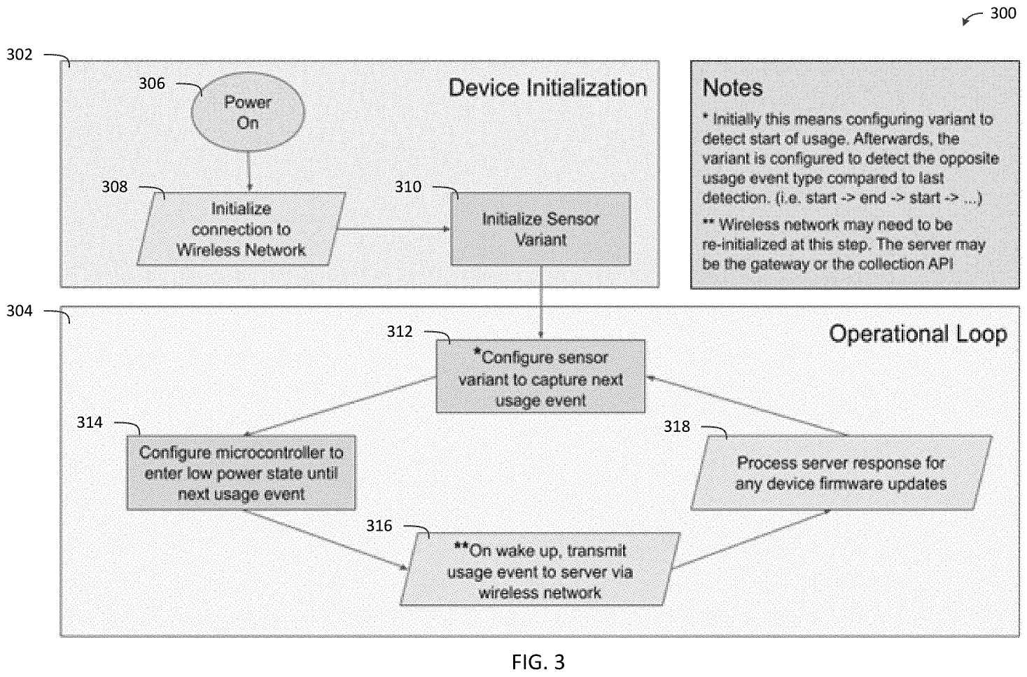

Now referring to FIG. 3, a high level description 300 of the sensor's operation in accordance with one embodiment of the present invention is shown. The sensor's operation includes device initialization 302 and an operational loop 304. During device initialization 302, the sensor powers on in block 306, initializes a connection to the wireless network in block 308 and initializes the sensor variant in block 301. Thereafter in the operation loop 304, the sensor variant is configured to capture the next usage event in block 312, configures the microcontroller to enter low power state until the next usage event in block 314, transmits usage event to server via wireless network on wake up in block 316, processes the server response for any device firmware updates in block 318, and loops back to block 312. Note that in block 312, this means initially configuring the variant to detect start of usage. Afterwards, the variant is configured to detect the opposite usage event type compared to last detection (i.e., start->end-> start-> . . . ). Note also in block 314, the wireless network may need to be re-initialized at this step. The server may be the gateway or the collection API.

The process flow described generalizes the sensor variant, and the flow should not change for most, if not all, sensor variants used for the sensor. The flow chart does not address how the sensor transmits its periodic heartbeat message. A possible modification to the flow to implement the heartbeat can be to configure a timeout on the low power state. Then if the device wakes up and detects no usage event, the device will transmit the heartbeat message. More details related to the heartbeat are described below.

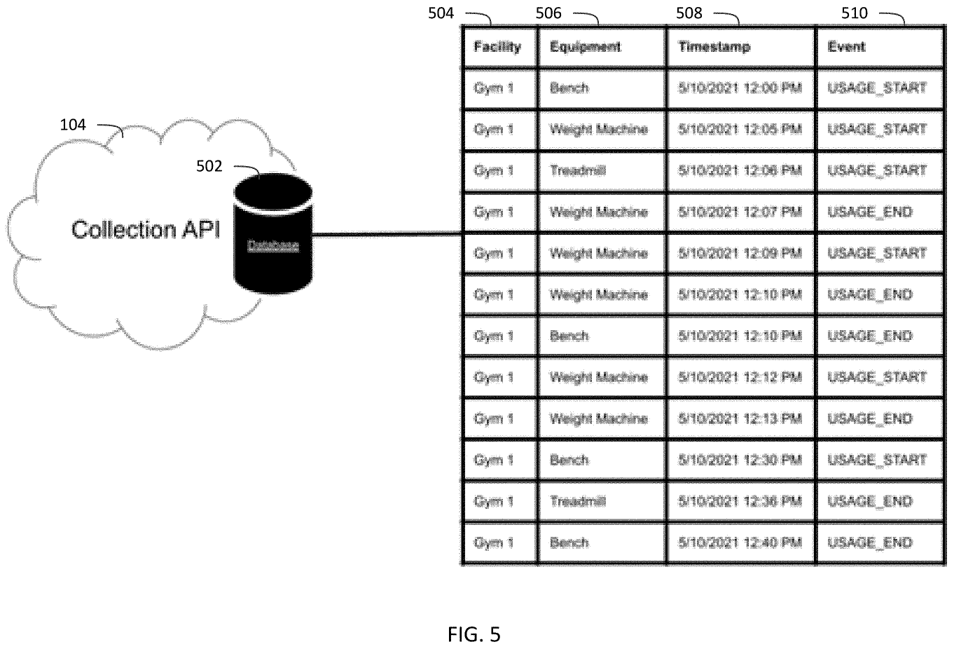

Referring now to FIG. 4, a block diagram of a gateway network configuration overview 400 in accordance with one embodiment of the present invention is shown. As mentioned before, the sensors 102 are mostly in a low power state which causes them to be disconnected from their wireless network (e.g., private wireless network 402 hosted by gateway 108). Given that the collection API 104 is most likely accessed over the internet 404, some maintenance challenges present themselves. The sensor 102 will have inevitable maintenance needs related to network configuration and other software/firmware upgrades. Given that the sensors 102 spend most of their time disconnected from their wireless network 402 in a low power state, it is challenging to streamline the processes needed to address these needs. On the other hand, the low power nature of the sensor 102 also makes it imperative that any maintenance needs related to network connectivity are addressed in a timely fashion to minimize data loss.

The gateway 108 addresses these issues. A gateway 108 is a computer, microcontroller or other device that, unlike the sensors 102, is expected to always be connected to a reliable power grid and a wireless or wired communications network. The gateway 108 creates a secure private network and an intermediary API that are used by the sensors 102 to transmit usage data in real time. The gateway 108 also maintains any network connection needed for accessing the collection API 104.

In the event the collection API 104 becomes inaccessible, the gateway 108 caches any data it receives from sensors 102 over the private network 402. Upon restoration of collection API 104 access, the gateway 108 transmits all cached data to the collection API 104 to prevent any data loss. During times of normal connectivity, the gateway 108 immediately transmits all received sensor data to the collection API 104.

The wireless or wired network connection 404 with the collection API 104 is also used to deploy any software/firmware upgrades to the sensors 102 via the gateway 108. The update is cached by the gateway 108 and rolled out to sensors 102 as they connect to either report usage events or their heartbeat.

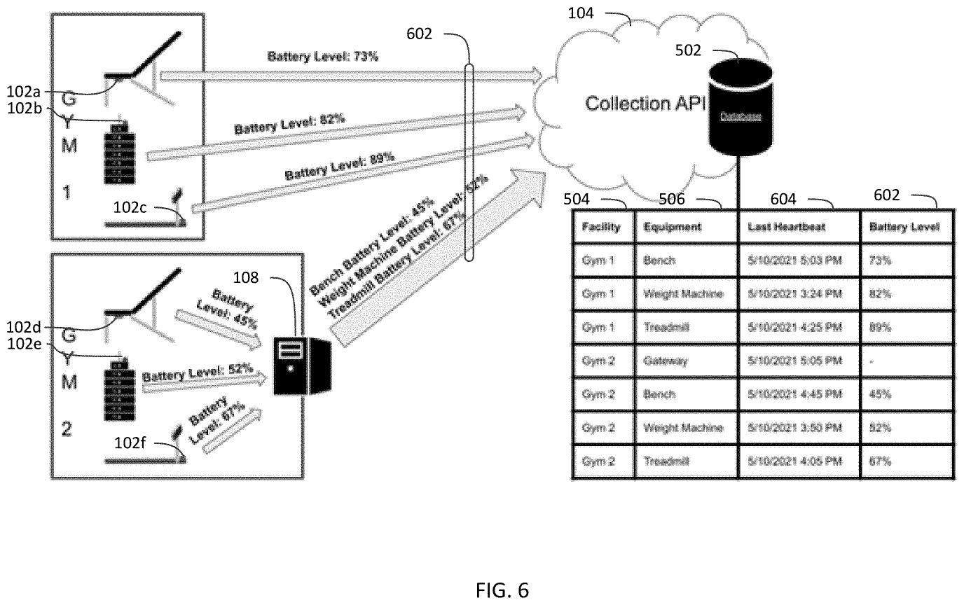

Now referring to FIGS. 5 and 6, non-limiting examples of the type of data stored by the collection API 104 in accordance with one embodiment of the present invention is shown. The collection API 104 is essentially the central multi-tenant repository for all usage data. It is accessed via network, typically the internet. Sensors transmit usage data either via a direct connection or indirectly via a gateway. Applications built to address various presentation layer use cases directly access the database storing usage data collected by the collection API 104. As shown in FIG. 5, the sensor data stored in the database 502 associated with the collection API 104 may include a facility identifier 504 (e.g., Gym 1, etc.), an equipment identifier 506 (e.g., Bench, etc.), a timestamp 508 (e.g., 5/10/2021 12:00 PM, etc.), and an event identifier 510 (e.g., USAGE_START, etc.). Other types of data can be received from the sensors and stored in the database 502. As shown in FIG. 6, the sensors 102 may also transmit battery levels 602 to the collection API 104. For example, sensor 102a transmits a battery level of 73% to the collection API 104; sensor 102b transmits a battery level of 82% to the collection API 104; sensor 102c transmits a battery level of 89% to the collection API 104; sensor 102d transmits a battery level of 45% to the collection API 104 via gateway 108; sensor 102e transmits a battery level of 52% to the collection API 104 via gateway 108; and sensor 102e transmits a battery level of 67% to the collection API 104 via gateway 108. The sensor data stored in the database 502 associated with the collection API 104 may include the facility identifier 504 (e.g., Gym 1, etc.), an equipment identifier 506 (e.g., Bench, etc.), a last heartbeat 604 (e.g., 5/10/2021 5:03 PM, etc.), and a battery level 602 (e.g., 73%, etc.).

The presentation layer will now be described. Using applications built to address various presentation layer use cases, the equipment usage data captured via the collection API is accessible to end users on a near real-time basis and through a multitude of network connected devices. This includes, but is not limited to, computers, laptops, mobile phones, personal data assistants, tablets, watches, wrist bands, or any other existing or future communications device used by end users. The presentation layer use cases include, but are not limited to, historical usage of each tracked equipment, as well as near real time gauges or heat maps indicating overall usage or busyness of the fitness center. The data can be accessed via a server running the collection API or from a database.

Presentation layer applications developed for the benefit of fitness center operators can aggregate and curate the collected data to illustrate what types of workouts are being completed by end users (e.g., rep count, average weight, etc.) and present a more holistic view of exercise equipment usage.

Presentation layer applications developed for the benefit of end users of fitness centers can allow the user to claim repetition and weight data, along with any other relevant usage events, collected by the sensors as being related to the end user's workouts. The ability for users to claim data collected by sensors can be allowed before, during, or after the usage events collected by the sensors. For example, the user can use their presentation layer application to configure a time in future they intend to use certain exercise equipment. As the system backend receives usage data from sensors, usage events from the configured equipment can automatically be marked as belonging to the end user's workout history. In addition, the end user can use their presentation layer application to review usage events collected for an equipment in near real time or a later time and mark any they desire to be part of their workout history.

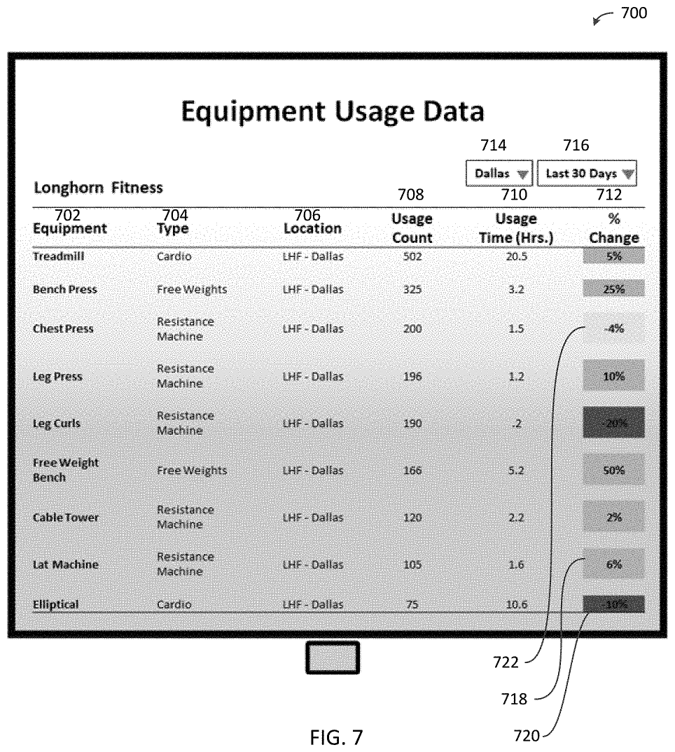

Referring now to FIG. 7, an example of the historical usage of exercise equipment use case 700 as presented via a web browser on a desktop personal computer or laptop in accordance with one embodiment of the present invention is shown. Fitness center operators, an intended audience of this use case, can review equipment usage data on a per equipment basis and broken out by specific fitness center locations. Equipment usage is presented in terms of total duration in use as well as a total count of usage occurrences. For example, equipment identifier 702, equipment type 704, location identifier 706, usage count 708, usage time 710, and percent change 712. Fitness center operators can also filter the data by specific locations 714, equipment types 704 and time period 716, along with other relevant parameters. A use case like the one in FIG. 7 enables fitness center operators with the ability to see usage data across all their facilities on demand.

In addition to raw equipment usage data collected from the sensor devices, FIG. 7 also includes an example of presenting data inferred from the raw data reported by sensors. The specific example in FIG. 7 shows data concerning changes in usage rates for individual equipment. Use cases involving inferred data are relevant for both long-term strategic matters and day-to-day maintenance of gyms. The example in FIG. 7 highlights negative and positive changes in equipment usage rates over the selected time period. Negative changes, or drop in usage, are highlighted in red 718, while positive changes, or increase in usage, are highlighted in green 720, and nominal negative changes, or little drops in usage, are highlighted in yellow 722. Other colors or visual indicators can be used.

Fitness center operators can track this data to gauge whether particular equipment is either falling out of favor with users or may potentially be damaged and need repair. Having such timely intelligence about one's fitness center results in quicker response times by fitness center operators in addressing any maintenance work in the gym. Inferred data consumed for purposes of timely maintenance does not have to be consumed on demand. Instead such data can be even more timely in the form of alerts. A use case in this scenario would involve informing operators about significant drops in usage of equipment via email, SMS, or a similar notification mechanism.

The collected data from the sensors can also be used to send alerts to both fitness center operators and users concerning relevant matters. For operators, equipment with potential defects can be identified by highlighting material changes in usage data over a period of time. If an equipment goes from being used 40+ times a day to no usage for multiple days, we can alert operators to check on the equipment for potential issues. This alert will be highlighted in both daily usage reports and one-off notifications to operators.

For users, timely notifications can be sent around equipment availability. As tracking data shows no usage event for a period of time, it can be inferred that the equipment is not being used and this information can be passed onwards to interested parties. Fitness center users can select to be notified of an equipment's availability via a presentation layer application geared towards them, where they can also have access to real-time equipment availability information across the gym. Such capabilities allow end users to schedule trips to the fitness center when machines they are interested in using are available.

Additionally, the data collected by the sensors can be used to predict future usage of equipment and machines at a fitness center. Given the sensors in practice will be operating throughout the day at a fitness center, the collected data will provide key insights into precisely when an equipment or machine is used. Over a period of time, this information can be leveraged to accurately understand typical usage trends for exercise equipment inside a fitness center at various levels of granularity with respect to time.

The ability to predict equipment usage trends will be valuable to both fitness center operators and users. Operators can harness this information to better plan and execute both day-to-day and long-term operational tasks inside the fitness center. For example, periodic installation and maintenance of exercise equipment and fitness center itself can be planned during appropriate occupancy levels.

Operators can also forecast exercise equipment replacement needs by accessing usage count from the data captured. This information can help operators be more proactive in addressing any potential problems with equipment that cause them to become out of commission for a period of time.

End users of fitness centers can also leverage similar information to make decisions on when to visit the fitness center based on expected occupancy levels. This is a critical piece of information for someone wanting to visit the gym during periods of low foot traffic. The data will be available to users on both a real time and historical basis. The real time data will show the exercise equipment currently in use. The historical data will complement this by forecasting the expected level of exercise equipment usage, which can also be inferred as expected foot traffic inside a fitness center at different hours of the day.

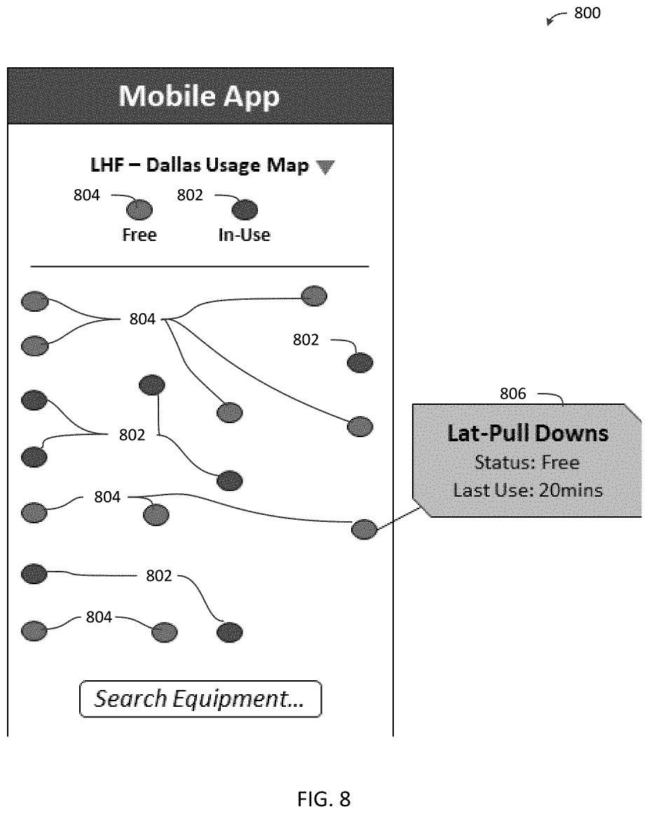

In addition to the presentation layer use cases for fitness center operators, FIG. 8 highlights a presentation layer use case for fitness center users. FIG. 8 shows an illustrative example of a heat map feature 800 for fitness center users to access on their mobile phones or tablets and check on equipment availability and how busy a fitness center is at any given moment. For example, fitness center users can see the occupancy/use status of each equipment in a selected fitness center on both an aggregate and individual basis. The heat map turns red for any equipment in use 802 and remains green for those that are currently not in use 804. By tapping on a particular equipment or searching for it by name in the search box, fitness center users can see its current use status and, if the equipment is unused, the last time the equipment was used. The physical location of the equipment within the fitness center or a portion of the fitness center can be graphically illustrated by the location of ovals on the screen. This last feature is highlighted with the “Lat Pull Downs” equipment breakout 806 showing the status as “Free” and last use “20 mins”.

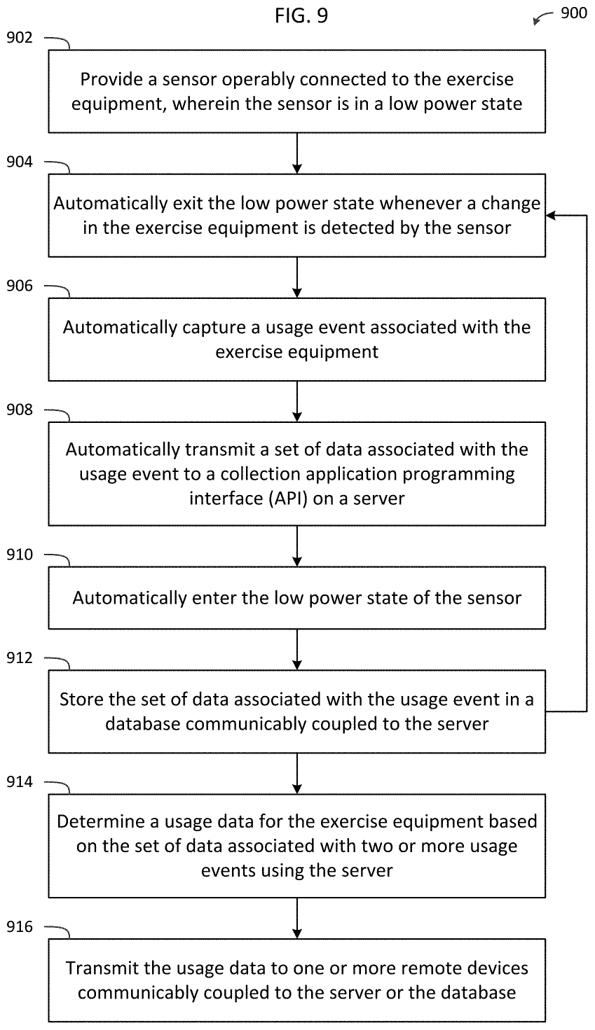

Now referring to FIG. 9, a flow chart illustrating a computerized method 900 of tracking a usage of an exercise equipment in accordance with one embodiment of the present invention is shown. A sensor is operably connected to the exercise equipment is provided in block 902. The sensor is in a low power state. The sensor automatically exits the low power state whenever a change in the exercise equipment is detected in block 904, automatically captures a usage event associated with the exercise equipment in block 906, automatically transmits a set of data associated with the usage event to a collection application programming interface (API) on a server in block 908, and automatically enters the low power state in block 910. The set of data associated with the usage event is stored in a database communicably coupled to the server in block 912. Steps 904 to 912 repeat for each detected usage event. A usage data is determined for the exercise equipment based on the set of data associated with two or more usage events using the server in block 914. The usage data is transmitted to one or more remote devices communicably coupled to the server or the database in block 916.

In one aspect, the method further comprises attaching the sensor to the exercise equipment, or integrating the sensor into the exercise equipment. In another aspect, the method further comprises initializing a wireless connection between the sensor and a wireless network. In another aspect, transmitting the set of data associated with the usage event to the collection application programming interface (API) on the server comprises: transmitting the set of data associated with the usage event from the sensor to a first wireless network; transmitting the set of data associated with the usage event from the sensor to a gateway via a first wireless network; and transmitting the set of data associated with the usage event from the gateway to the server via a second wireless network or wired network. In another aspect, the method further comprises storing the set of data associated with the usage event from the sensor at the gateway for later transmission whenever a connection to the server is lost or cannot be established. In another aspect, the method further comprises periodically and automatically exiting the low power state without any change in the exercise equipment, transmitting a heartbeat message to the collection application programming interface (API) on the server, and entering the low power state of the sensor. In another aspect, the heartbeat message comprising a facility identifier, an equipment identifier, a last heartbeat data, and a battery level. In another aspect, the method further comprises receiving an update from the server, and installing the update on the sensor. In another aspect, the usage event comprises a start of the exercise equipment or a stop of the exercise equipment. In another aspect, the set of data associated with the usage event comprises a facility identifier, an equipment identifier, a timestamp and an event identifier. In another aspect, the sensor operates automatically without any action by a user. In another aspect, the usage data is determined in response to a request from the one or more remote devices. In another aspect, the method further comprises detecting a problem with the exercise equipment based on the usage data. In another aspect, the method further comprises displaying a current usage or a future usage for the exercise equipment or multiple exercise equipment on the one or more remote devices. In another aspect, the method further comprises associating the usage data with a user, wherein the usage data is only available to the user and an operator or owner of the exercise equipment. In another aspect, the method further comprises sending one or more alerts to the one or more remote devices. In another aspect, the usage data is transmitted to the one or more remote devices in real time or near real time. In another aspect, the sensor comprises: an enclosure; one or more sensing elements disposed on or within the enclosure; a microcontroller disposed within the enclosure and connected to the one or more sensing elements; and a power source disposed on or within the enclosure and connected to the one or more sensing elements and the microcontroller. In another aspect, the one or more sensing elements comprise a motion sensor, a vibration sensor, or a seat occupancy sensor. In another aspect, the power source comprises a battery, an electromagnetic energy harvester, a solar cell, or a combination thereof. In another aspect, the method further comprises the sensor interoperates or communicates with an exercise tracking component of the exercise equipment or a personal exercise tracking device. In another aspect: the exercise equipment comprises a weight lifting equipment, a cardio equipment, a dueling ropes, a stretching center, or an ab machine; and the remote device comprises a computer, a laptop, a mobile phone, a personal data assistant, a tablet, a watch, or a wrist band.

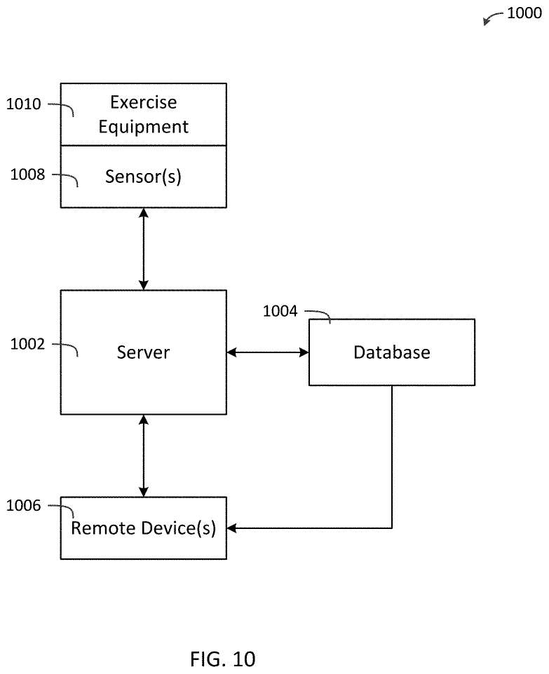

Referring now to FIG. 10, a block diagram of system 1000 for tracking a usage of an exercise equipment in accordance with one embodiment of the present invention is shown. The system includes a server 1002, a database 1004 communicably coupled to the server 1002, one or more remote devices 1006 communicably coupled to the server 1002 or the database 1004, and one or more sensors 1008 operably connected to the exercise equipment 1010. The sensor 1008 is in a low power state, automatically exits the low power state whenever a change in the exercise equipment 1010 is detected, automatically captures a usage event associated with the exercise equipment 1010, automatically transmits a set of data associated with the usage event to a collection application programming interface (API) 1012 on the server 1002, and automatically enters the low power state. The server 1002 stores the set of data associated with the usage event in the database 1004, and determines a usage data for the exercise equipment 1010 based on the set of data associated with two or more usage events. The server 1002 or the database 1004 transmits the usage data to the one or more remote devices 1006 communicably coupled to the server 1002 or the database 1004.

In one aspect, the sensor is attached to the exercise equipment, or integrated into the exercise equipment. In another aspect, the sensor initializes a wireless connection with a wireless network. In another aspect, the system further comprises: a gateway; a first wireless network communicably coupling the sensor to the gateway; and a second wireless network or wired network communicably coupling the gateway to the server. In another aspect, the set of data associated with the usage event from the sensor is stored at the gateway for later transmission whenever a connection to the server is lost or cannot be established. In another aspect, the sensor periodically and automatically exits the low power state without any change in the exercise equipment, transmits a heartbeat message to the collection application programming interface (API) on the server, and enters the low power state of the sensor. In another aspect, the heartbeat message comprising a facility identifier, an equipment identifier, a last heartbeat data, and a battery level. In another aspect, the sensor receives an update from the server, and installs the update. In another aspect, the usage event comprises a start of the exercise equipment or a stop of the exercise equipment. In another aspect, the set of data associated with the usage event comprises a facility identifier, an equipment identifier, a timestamp and an event identifier. In another aspect, the sensor operates automatically without any action by a user. In another aspect, the usage data is determined in response to a request from the one or more remote devices. In another aspect, a problem with the exercise equipment is detected based on the usage data. In another aspect, a current usage or a future usage for the exercise equipment or multiple exercise equipment is displayed on the one or more remote devices. In another aspect, the usage data is associated with a user, wherein the usage data is only available to the user and an operator or owner of the exercise equipment. In another aspect, one or more alerts are sent to the one or more remote devices. In another aspect, the usage data is transmitted to the one or more remote devices in real time or near real time. In another aspect, the sensor comprises: an enclosure; one or more sensing elements disposed on or within the enclosure; a microcontroller disposed within the enclosure and connected to the one or more sensing elements; and a power source disposed on or within the enclosure and connected to the one or more sensing elements and the microcontroller. In another aspect, the one or more sensing elements comprise a motion sensor, a vibration sensor, or a seat occupancy sensor. In another aspect, the power source comprises a battery, an electromagnetic energy harvester, a solar cell, or a combination thereof. In another aspect, the sensor interoperates or communicates with an exercise tracking component of the exercise equipment or a personal exercise tracking device. In another aspect: the exercise equipment comprises a weight lifting equipment, a cardio equipment, a dueling ropes, a stretching center, or an ab machine; and the remote device comprises a computer, a laptop, a mobile phone, a personal data assistant, a tablet, a watch, or a wrist band.

In another embodiment of the present invention, a system for tracking a usage of an exercise equipment includes: a server; a database communicably coupled to the server; one or more remote devices communicably coupled to the server or the database; one or more sensors operably connected to the exercise equipment, wherein each sensor comprises, an enclosure, one or more sensing elements disposed on or within the enclosure, a microcontroller disposed within the enclosure and connected to the one or more sensing elements, and a power source disposed on or within the enclosure and connected to the one or more sensing elements and the microcontroller, and wherein each sensor is in a low power state, automatically exits the low power state whenever a change in the exercise equipment is detected, automatically captures a usage event associated with the exercise equipment, automatically transmits a set of data associated with the usage event to a collection application programming interface (API) on the server, and automatically enters the low power state; a gateway; a first wireless network communicably coupling the one or more sensors to the gateway; a second wireless network or wired network communicably coupling the gateway to the server; wherein the server stores the set of data associated with the usage event in the database, and determines a usage data for the exercise equipment based on the set of data associated with two or more usage events; and wherein the server or the database transmits the usage data to the one or more remote devices.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%. All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A computerized method of tracking a usage of an exercise equipment comprising:
providing a sensor operably connected to the exercise equipment, wherein the sensor is in a low power state;
automatically exiting the low power state whenever a change in the exercise equipment is detected by the sensor;
automatically capturing a usage event associated with the exercise equipment;
automatically transmitting a set of data associated with the usage event to a collection application programming interface (API) on a server;
automatically entering the low power state of the sensor;
storing the set of data associated with the usage event in a database communicably coupled to the server;
determining a usage data for the exercise equipment based on the set of data associated with two or more usage events using the server; and
transmitting the usage data to one or more remote devices communicably coupled to the server or the database.

2. The method of claim 1, further comprising initializing a wireless connection between the sensor and a wireless network.

3. The method of claim 1, wherein transmitting the set of data associated with the usage event to the collection application programming interface (API) on the server comprises:
transmitting the set of data associated with the usage event from the sensor to a first wireless network;
transmitting the set of data associated with the usage event from the sensor to a gateway via a first wireless network; and
transmitting the set of data associated with the usage event from the gateway to the server via a second wireless network or wired network.

4. The method of claim 3, further comprising storing the set of data associated with the usage event from the sensor at the gateway for later transmission whenever a connection to the server is lost or cannot be established.

5. The method of claim 1, further comprising periodically and automatically exiting the low power state without any change in the exercise equipment, transmitting a heartbeat message to the collection application programming interface (API) on the server, and entering the low power state of the sensor.

6. The method of claim 5, wherein the heartbeat message comprising a facility identifier, an equipment identifier, a last heartbeat data, and a battery level.

7. The method of claim 1, further comprising receiving an update from the server, and installing the update on the sensor.

8. The method of claim 1, wherein the usage event comprises a start of the exercise equipment or a stop of the exercise equipment.

9. The method of claim 1, wherein the set of data associated with the usage event comprises a facility identifier, an equipment identifier, a timestamp and an event identifier.

10. The method of claim 1, wherein the sensor operates automatically without any action by a user.

11. The method of claim 1, wherein the usage data is determined in response to a request from the one or more remote devices.

12. The method of claim 1, further comprising predicting a future usage or a usage trend for the exercise equipment based on the usage data and a historical usage.

13. The method of claim 1, further comprising detecting a problem with the exercise equipment based on the usage data.

14. The method of claim 1, further comprising displaying a current usage or a future usage for the exercise equipment or multiple exercise equipment on the one or more remote devices.

15. The method of claim 1, further comprising associating the usage data with a user, wherein the usage data is only available to the user and an operator or owner of the exercise equipment.

16. The method of claim 1, further comprising sending one or more alerts to the one or more remote devices.

17. The method of claim 1, wherein the usage data is transmitted to the one or more remote devices in real time or near real time.

18. The method of claim 1, wherein the sensor interoperates or communicates with an exercise tracking component of the exercise equipment or a personal exercise tracking device.

19. A system for tracking a usage of an exercise equipment comprising:
a server;
a database communicably coupled to the server;
one or more sensors operably connected to the exercise equipment, wherein the sensor is in a low power state, automatically exits the low power state whenever a change in the exercise equipment is detected, automatically captures a usage event associated with the exercise equipment, automatically transmits a set of data associated with the usage event to a collection application programming interface (API) on the server, and automatically enters the low power state; and
wherein the server stores the set of data associated with the usage event in the database, and determines a usage data for the exercise equipment based on the set of data associated with two or more usage events.

20. The system of claim 19, further comprising one or more remote devices communicably coupled to the server or the database, wherein the server or the database transmits the usage data to the one or more remote devices.

21. The system of claim 19, wherein the sensor is attached to the exercise equipment, or integrated into the exercise equipment.

22. The system of claim 19, further comprising:
a gateway;
a first wireless network communicably coupling the sensor to the gateway; and
a second wireless network or wired network communicably coupling the gateway to the server.

23. The system of claim 22, wherein the set of data associated with the usage event from the sensor is stored at the gateway for later transmission whenever a connection to the server is lost or cannot be established.

24. The system of claim 19, wherein the sensor periodically and automatically exits the low power state without any change in the exercise equipment, transmits a heartbeat message to the collection application programming interface (API) on the server, and enters the low power state of the sensor.

25. The system of claim 24, wherein the heartbeat message comprising a facility identifier, an equipment identifier, a last heartbeat data, and a battery level.

26. The system of claim 19, wherein the usage event comprises a start of the exercise equipment or a stop of the exercise equipment.

27. The system of claim 19, wherein the set of data associated with the usage event comprises a facility identifier, an equipment identifier, a timestamp and an event identifier.

28. The system of claim 19, wherein the sensor operates automatically without any action by a user.

29. The system of claim 19, wherein the usage data is determined in response to a request from one or more remote devices.

30. The system of claim 19, further comprising predicting a future usage or a usage trend for the exercise equipment based on the usage data and a historical usage.

31. The system of claim 19, further comprising detecting a problem with the exercise equipment based on the usage data.

32. The system of claim 19, further comprising displaying a current usage or a future usage for the exercise equipment or multiple exercise equipment on one or more remote devices.

33. The system of claim 19, further comprising associating the usage data with a user, wherein the usage data is only available to the user and an operator or owner of the exercise equipment.

34. The system of claim 19, further comprising sending one or more alerts to one or more remote devices.

35. The system of claim 19, wherein the usage data is transmitted to one or more remote devices in real time or near real time.

36. The system of claim 19, wherein the sensor comprises:
an enclosure;
one or more sensing elements disposed on or within the enclosure;
a microcontroller disposed within the enclosure and connected to the one or more sensing elements; and
a power source disposed on or within the enclosure and connected to the one or more sensing elements and the microcontroller.

37. The system of claim 36, wherein the one or more sensing elements comprise a motion sensor, a vibration sensor, or a seat occupancy sensor.

38. The system of claim 36, wherein the power source comprises a battery, an electromagnetic energy harvester, a solar cell, or a combination thereof.

39. The system of claim 19, wherein the sensor interoperates or communicates with an exercise tracking component of the exercise equipment or a personal exercise tracking device.

40. The system of claim 19, wherein:
the exercise equipment comprises a weight lifting equipment, a cardio equipment, a dueling ropes, a stretching center, or an ab machine; and
the remote device comprises a computer, a laptop, a mobile phone, a personal data assistant, a tablet, a watch, or a wrist band.

41. A system for tracking a usage of an exercise equipment comprising:
a server;
a database communicably coupled to the server;
one or more remote devices communicably coupled to the server or the database;
one or more sensors operably connected to the exercise equipment, wherein each sensor comprises, an enclosure, one or more sensing elements disposed on or within the enclosure, a microcontroller disposed within the enclosure and connected to the one or more sensing elements, and a power source disposed on or within the enclosure and connected to the one or more sensing elements and the microcontroller, and wherein each sensor is in a low power state, automatically exits the low power state whenever a change in the exercise equipment is detected, automatically captures a usage event associated with the exercise equipment, automatically transmits a set of data associated with the usage event to a collection application programming interface (API) on the server, and automatically enters the low power state;
a gateway;
a first wireless network communicably coupling the one or more sensors to the gateway;
a second wireless network or wired network communicably coupling the gateway to the server;
wherein the server stores the set of data associated with the usage event in the database, and determines a usage data for the exercise equipment based on the set of data associated with two or more usage events; and
wherein the server or the database transmits the usage data to the one or more remote devices.
